(19) United States
(12) Patent Application Publication
(10) Pub. No.: US 2009/0249255 A1
(43) Pub. Date: Oct. 1, 2009

(54) Method of and System for Adaptive Suggestion of Directories When Saving Files

(76) Inventors: Nils Haustein, Soergenloch (DE); Craig A. Klein, Tucson, AZ (US); Daniel J. Winarski, Tucson, AZ (US)

Correspondence Address: DILLON & YUDELL LLP, 8911 NORTH CAPITAL OF TEXAS HWY, SUITE 2110, AUSTIN, TX, 78759, US

(21) Appl. No.: 12/059,621

(22) Filed: Mar. 31, 2008

(51) Int. Cl. G06F 3/048

(52) U.S. Cl. 715/840

(57) ABSTRACT

A method of adaptively suggesting directories when saving files receives a request to save a file. The file has a file name and the file was prepared with an application. If a portion of the file name and the application with which the file was prepared are associated in the table with a single directory, the method suggests the single directory for saving the file in the single directory. If the portion of the file name and the application are associated in a table with multiple directories, the method suggests one of the multiple directories having a greatest count value for saving the file. If a user saves the file in the single directory, the method increments a count value in the table for the single directory and updates a time and date in the table for the single directory. If the user saves the file in the one of the directories having the greatest count value, the method increments the count value in the table for the one of the directories having the greatest count value and updates the date and time in the table for the one of the directories having the greatest count value a date and time.

### BACKGROUND OF THE INVENTION

1. Technical Field

The present invention relates in general to the field of computer graphical user interfaces, and more particularly to a graphical user interface that adaptively suggests directories when saving files.

2. Description of the Related Art

Users create files using applications. For example, users may create spreadsheet files using Microsoft Excel, documents using Microsoft Word, and presentations using Microsoft PowerPoint. When the user wishes to store a new file, the user invokes a SAVE AS dialog from the File action bar.

The SAVE AS dialog enables the user to choose a directory into which to save the file. Typically, the dialog presents a default directory. The dialog may also enable the user to choose a directory from a list of most recently used directories. If the user does not want to store the file in the default directory or one of the most recently used directories, the user can enter the name of a directory or navigate through a directory tree to the appropriate directory.

Currently, the SAVE AS dialog does not associate the context of a file name or application with the presentation of directories. Many users do not know or cannot type accurately the name of a particular directory. It is time-consuming to navigate through a directory tree to find the appropriate directory. Accordingly, the current SAVE AS dialog may be relatively inefficient.

### SUMMARY OF THE INVENTION

The present invention provides a method of and a system for adaptively suggesting directories when saving files. The method receives a request to save a file. The file has a file name and the file was prepared with an application. The method determines if a portion of the file name and the application are associated in a table with a directory. If the portion of the file name and the application are associated in the table with a single directory, the method suggests the single directory for saving the file in the single directory. If the method saves the file in the single directory, the method increments a count value in the table for the single directory and updates a time and date in the table for the single directory. If the file is not saved in the single directory, the method associates the portion of the file name and the application in the table with a directory into which the file is saved.

If the portion of the file name and the application are associated in a table with multiple directories, the method suggests one of the multiple directories having a greatest count value for saving the file. If the file is saved in the one of the directories having the greatest count value, the method increments the count value in the table for the one of the directories having the greatest count value and updates the date and time in the table for the one of the directories having the greatest count value a date and time. If the file is not saved in the one of the multiple directories having the greatest count value, the method associates the portion of the file name and the application in the table with a directory into which the file is saved. If the portion of the file name and the application are not associated in a table with a directory, the method associates the file name and the application with the directory into which the file is saved and enters a date and time in the table for the directory.

The method periodically checks the table. If a most recent date for a directory is earlier than a threshold date, the method decrements the count for the directory. If the decremented count is equal to zero, the method deletes the directory from the table.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an embodiment of a SAVE AS dialog according to the present invention;

FIG. 2 illustrates an embodiment of directory table according to the present invention;

FIG. 3 is a flow chart of an embodiment of SAVE AS processing to the present invention; and,

FIG. 4 is a flow chart of an embodiment of directory table processing according to the present invention.

### DETAILED DESCRIPTION OF THE PREFERRED EMBODIMENT

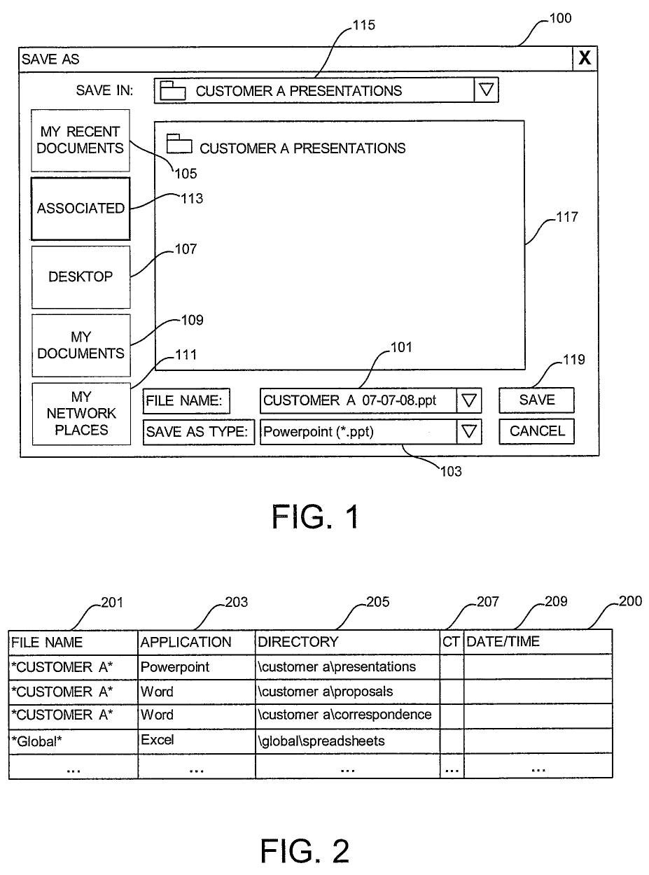

Referring now to drawings, and first to FIG. 1, an embodiment of a SAVE AS dialog according to the present invention is designated generally by the numeral 100. As is known to those skilled in the art, a SAVE AS dialog is displayed in response to selection of SAVE AS from the File drop-down menu in an application window. The SAVE AS function is typically invoked after a user creates a new document or other work product. In dialog 100, the user has created a file called CUSTOMER A 07-07-08.ppt, as indicated in file name box 101. As indicated in SAVE AS TYPE box 103, the file to be saved is a PowerPoint file, which has been created using the Microsoft PowerPoint application.

SAVE AS dialog 100 provides a graphical way for a user to save a file in a particular directory. In dialog 100, directories are represented using the folder metaphor. Dialog 100 includes buttons by which categories of directories into which a file may be saved may be presented to the user. These buttons include a MY RECENT DOCUMENTS button 105, a DESKTOP button 107, a MY DOCUMENTS button 109, and a MY NETWORK PLACES button 111. According to an embodiment of the present invention, dialog 100 includes an ASSOCIATED button 113. As will be explained in detail hereinafter, actuation of ASSOCIATED button 113 causes the system to suggest to the user an appropriate folder or directory in which to save the file based upon the name of the file and the application used to create the file.

As shown in FIG. 1, selection of ASSOCIATED button 113 causes SAVE AS dialog 100 to suggest CUSTOMER A PRESENTATIONS as the appropriate directory in which to save file CUSTOMER A 07-07-08.ppt. The suggestion of CUSTOMER A PRESENTATIONS directory is presented in save in box 115 and Field 117. In the example of FIG. 1, there is only one associated directory according to file name and application used to create the file. However, occasionally, a user may have saved files having the same or similar file name and created using the same application in different directories. In those cases, as will be explained in detail hereinafter, the method of the present invention presents multiple directories in field 117 and enables the user to select which directory into which to save the file. The user can save the file into the suggested directory by actuating SAVE button 119.

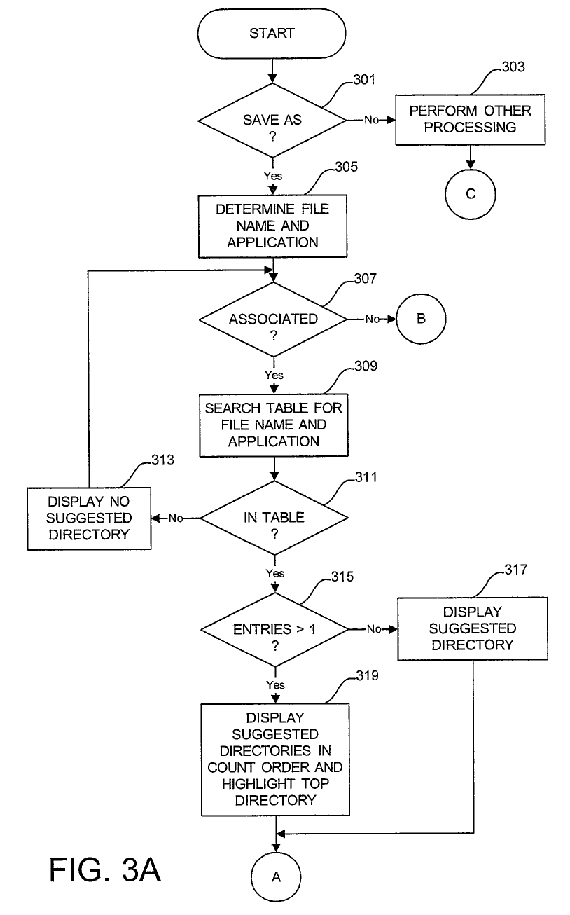

FIG. 2 illustrates an embodiment of the directory table 200 according to the present invention. Table 200 includes a file name column 201, an application column 203, a directory column 205, a count column 207, and a date/time column 209. File name column 201 contains pertinent portions of file names. Application column 203 contains the name of the application used to create a file. Directory column 205 contains the directory into which files having the file name including the information in file name column 201 created with the application identified in column 203 have been saved. As will be explained in detail hereinafter, count column 207 indicates the number of times associated files have been saved into a particular directory. Date/time column 209 indicates the date and time that an associated file was last saved into a particular directory. Each row in table 200 represents a directory entry which maps a file name pattern 201 of a file created by an application 203 to directory 205 where the file with said name pattern was last saved. Each directory entry has a count 207 which indicates how often file with said name pattern created by said application has been saved in said directory 205; and a date and time stamp 209 indicating when which indicates when a file with said name pattern created by said application has been saved in said directory 205.

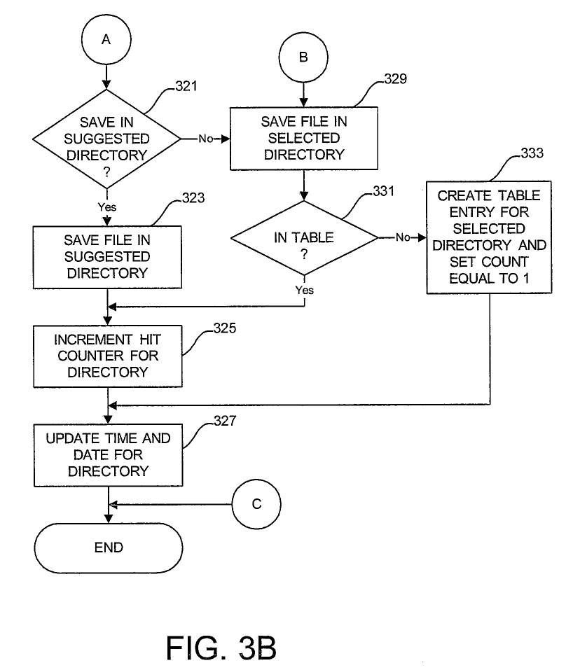

FIG. 3 is a flow chart of an embodiment of file SAVE AS processing according to the present invention. If, as determined at decision block 301, a user selects to save a file in a new directory, the method determines the file name and application, at block 305. If the user input is other than SAVE AS, the system performs other processing, as indicated at block 303, and processing according to FIG. 3 ends. If, as determined at decision block 307, the user chooses to have the method suggest associated directories for example by pressing the ASSOCIATED button 113 in SAVE AS dialog 100 of FIG. 1, the method matches the file name and application determined in step 305 to a directory 205 using the table, such as table 200 in FIG. 2, as indicated at block 309. If the user does not choose to have associated directories suggested, processing continues to FIG. 3B. If, as determined at decision block 311, no match is found for the file name and application in the table, the method displays no suggested directory, at block 313, and processing returns to decision block 307. If the file name and application are found and matched to a directory in the table, the method determines, at decision block 315, if there is more than one entry in the table. If there is one entry in the table then the method displays the suggested directory, at block 317. If there are more than one entry in the table, the method displays a suggested directories and count order and highlights the top directory, as indicated at block 319.

Turning to FIG. 3B entry point A, after the method has displayed a suggested directory or directories, the method determines if the user has selected to save the file in the suggested directory, at decision block 321. If so, the method saves the file in the suggested directory, at block 323. Then, the method increments the counter 207 in table 200 for the directory entry, at block 325, and updates the time and date field 209 in table 200 for the directory entry, at block 327. After block 327 the process ends.

Returning to decision block 321, if the user elects not to save the file in the suggested directory, the method saves the file in the selected directory, at block 329. Then, the method determines, at decision block 331, if there is an entry for the file name 201, application 203, and directory 205 in the table 200. If so, processing continues at block 325. If not, the method creates a entry in table 200 for the selected directory 205 including the file name 201 and the application 203 which created the file and sets the count 207 equal to one, at block 333. Then, processing continues at block 327.

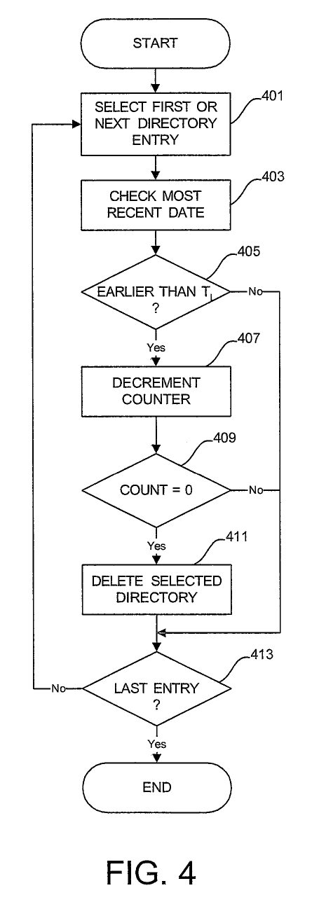

FIG. 4 is a flow chart of an embodiment of directory table 200 processing according to the present invention. Processing according to FIG. 4 may be performed periodically to demote or remove older directory entries from the directory table. The method selects a first or next directory entry from table 200, at block 401. The method checks the date and/or time entry 209 for the directory, at block 403. This entry represents the date that an associated file was last save in that directory. Then the method determines, at decision block 405, if the date entry is earlier than a threshold. The threshold is preconfigured by a user and might be set to the current data minus 90 days. Thus the decision in block 405 checks if an entry in table 200 is older than 90 days. If so, the method decrements the counter for that directory, at block 407. If, as determined at decision block 409, the count is equal to zero, the method deletes the selected directory, at block 411. Then, the method determines, at decision block 413, if the selected directory is the last entry in the table. If not, processing returns to block 401.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

1. A method of adaptively suggesting directories when saving files, which comprises:
receiving a request to save a file, said file having a file name and said file being prepared with an application;
determining if a portion of said file name and said application are associated in a table with a directory;
if said portion of said file name and said application are associated in said table with a single directory, suggesting said single directory for saving said file in said single directory;
if said file is saved in said single directory, incrementing a count value in said table for said single directory and updating in said table for said single directory a date and time;
if said file is not saved in said single directory, associating said portion of said file name and said application in said table with a directory into which said file is saved;
if said portion of said file name and said application are associated in a table with multiple directories, suggesting one of said multiple directories having a greatest count value for saving said file;
if said file is saved in said one of said directories having a greatest count value, incrementing said count vaiue in said table for said one of said directories having a greatest count value and updating in said table for said one of said directories having a greatest count value a date and time;
if said file is not saved in said one of said multiple directories having a greatest count value, associating said portion of said file name and said application in said table with a directory into which said file is saved; and,
if said portion of said file name and said application are not associated in a table with a directory, associating said file name and said application with a directory into which said file is saved and entering a date and time in said table for said directory.

2. The method as claimed in claim 1, further comprising:
periodically checking said table;
if a most recent date for a directory entry is earlier than a threshold date, decrementing said count for said directory; and,
if said decremented count is equal to zero, deleting said directory entry from said table.
